(19) United States
(12) Patent Application Publication
(10) Pub. No.: US 2002/0049817 A1
(43) Pub. Date: Apr. 25, 2002

(54) Storageless system and method for unified messaging on existing mail accounts via standard internet mail protocols

(76) Inventors: Eatamar Drory, Santa Clara, CA (US); Doron Herzlich, Ramat Hasharon (IL); Philippe Klein, Jerusalem (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/902,661

(22) Filed: Jul. 12, 2001

Related U.S. Application Data
(60) Provisional application No. 60/217,693, filed on Jul. 12, 2000.

(51) Int. Cl. G06F 15/16

(52) U.S. Cl. 709/206; 709/246

(57) ABSTRACT

A unified messaging system enables access to a variety of messaging devices and storage of messages in a single uniform e-mail attachment format. Furthermore, the system also provides e-mail messages to users without requiring said users to locally store said messages on a storage volume.

### RELATED APPLICATIONS

This application is based on and claims priority from U.S. Provisional Application No. 60/217,693, filed Jul. 12, 2000, which is incorporated herein by reference.

### BACKGROUND OF THE INVENTION

The need for unified messaging systems is rapidly evolving. The term ‘unified messaging system’ may be associated with a variety of meanings, yet the most common meaning refers to a system that allows its user to uniformly access and manage messages of several kinds and formats via a variety of access means. The term “managing messages” shall be referred hereinafter as including the ability, in regard to received messages, to move the message to folder, to create new folder containing the message, to delete the message, to retrieve the message, to distribute the message to a plurality of recipients, to automatically forward the message to predefined recipients, etc. In order to be able to communicate with, and handle messages of several kinds (i.e. different formats, protocols, accessibility etc.), unified messaging systems should be able not only to comply with various kinds of formats and protocols, but also to be able to handle stream-type media such as voice or video messages. Such messages are stored and transmitted differently than e-mail messages due to different requirements and design of transport and storage systems. This creates a constantly growing need for multiple large storage means that increase significantly the cost of the systems, as well as need for high bandwidth of the communication infrastructure. Typical architecture of e-mail systems is different from that of messaging systems. Typical transmission of e-mail messages over a network differs from the transmission of stream-type media in format and protocols. These differences make the integration of legacy systems into a messaging system very difficult.

FIG. 1 is a schematic description of the architecture of a typical messaging system 10 built and operating according to existing art. Messaging system 10 supports messaging services to a subscriber or user accessing the system via a variety of messaging means (such as e-mail client, WEB client, phone, etc.) 16. Various kinds of message sources 18, of different formats and protocols (such as phone, facsimile, WEB client, etc.) are interfaced to messaging system 10 via an aggregator unit 26. Aggregator unit may comprise hardware and/or software modules, typically at least some of them are proprietary solutions, made to meet the different needs of the different types and formats of each of the, message kinds.

Messages are stored on storage units related to their legacy media servers (i.e. faxes on fax servers, voice messages on voice message servers, etc). According to system 10 of FIG. 1, these servers may be a mail server 12, a fax server 13 or a voice mail server 14. Respectively, messages of Internet Messaging Access Protocol 4 (IMAP4) e-mail server 12 are stored in e-mail storage unit 20, messages of fax server 13 are stored in fax message storage unit and message of voice mail server are stored in voice mail storage unit 24.

Upon retrieval of a message, if the required retrieval is in the same format in which it was stored, that message will not undergo a change of format. Yet, a message of one format that is required to be retrieved in another format (such as a message received in text format and retrieved in fax format) must undergo a change of format upon retrieval. Aggregator unit 26 is made to present to the user a logically unified messaging system. In order to accomplish this goal, aggregator 26 identifies the type or format required for the stored message upon retrieval, and transforms the retrieved message into this format, if required. In messaging system 10 aggregator unit 26 may be regarded as a logical mailbox, but not as a real physical mailbox. Ex g it from the outside, messaging system 10 may look like a unified messaging system, yet messages are physically stored in a variety of formats and in a variety of storage units, It is hence very difficult to manage one message with multiple attachments of multiple formats (such as text and voice) in messaging systems working with aggregator unit. Accordingly, a voice message from a phone will be associated with voice mail server 14, while a message from a WEB client may be associated with e-mail server 12. Once an incoming message has been associated and transformed if needed, it is received by the server it has been associated with, and stored in its respective storage unit 20, 22 or 24. In order to browse a transformed and stored message, user 16 will contact the appropriate server, by addressing aggregator 26. In case the message to be browsed is of the e-mail type, user 16 may contact e-mail server 12 directly, thus establishing an alternative route of communication.

Transfer of electronic content (such as electronic messages) through a network involves a certain amount of delay (measured from the time a request to retrieve the content has been invoked until it is ready to be used on the retrieving side). Such a delay may be due to the number of servers, gateways and the like that the transferred message passes, the length of transmission lines etc. Such a delay is typically small. Other kinds of delays may be due to the methods used to transfer the content (e.g. packeting), and due to a low availability of channels. This delay is typically larger than the previous one.

With stream-type media (such as voice or video), another kind of delay may be involved. Due to its specific data construction, stream-type media may be played on the receiving side in one of two methods. If the stream-type media is retrieved using a protocol that supports streaming (such as Real Time Streaming Protocol (RTSP)), the receiver can start playing the received content before the content is fully received On the other hand, if the protocol used for retrieving the steam-type media does not support streaming, the received content cannot be played unless it is first fully received and stored. The delay involved with this phenomenon is even larger than the second one above.

FIG. 2A illustrates the flow of a stream-type message upon retrieval and playing of the message, where the protocol in use does not support streaming. In this figure the components of the system are drawn with solid lines and the flow of messages is drawn with dashed lines.

A stream-type message 140 is stored in message storage 132. A retrieval request 143 is invoked and as a result, a download operation 141 is performed in which a copy of the stream-type media message 142 is temporarily created in message storage unit 138 located near unified messaging system 136 to which the retrieving user is connected. Once the download of the message has been completed, the message is played (labeled 144) to the user. With this method of retrieval, latency of response (the time from when a subscriber activates the retrieval command and until this message is played to him) may be very short and even unnoticeable for a single user at a time, Yet, when the number of users requesting retrieval of stream-type media at the same time, in the same route, exceeds the maximum number of available concurrent channels, the latency may become too large for the user, due to the accumulative nature of this phenomenon. Hence, a system in which retrieval of stream-type media uses a protocol that does not support streaming, could be referred as a non-scalable system (i.e. the number of users that can use it concurrently is heavily restricted) due to latency requirements. Scalability in messaging system is the ability to expand the system in multiple dimensions (for which, it is desired to have small granularity in each dimension), the dimensions may include the number of active users in the system, the number of messages per user and the distribution of the system geographically.

In order to somehow overcome such latency problems, another method of retrieval of stream-type media is used, as illustrated in FIG. 2B. System 150 employs message storage 152 in operative connection with a server 154. Server 154 is in operative connection with a messaging system 156, which is in operative connection with a temporary storage 158.

According to this method, before any retrieval is requested, a prediction is performed (not shown in the drawing) to predict which users may possibly wish to retrieve a specific stream-type message. Accordingly, duplicate copy 162 of that message 160 is created in advance, downloaded and stored in storage unit 158 located near the streaming unit at server 156 nearest to the location of the access unit the user might use to retrieve the message. Now, when retrieval of the message is requested (labeled 163), the stream-type media content is fetched from message storage 152 and stored in local message storage 158, thus avoiding the accumulation of multiple downloads. Thus the latency problem described above may be lowered.

The system of FIG. 28 requires more storage space then that of FIG. 2A Furthermore, duplicates of a message created as described above impose synchronization requirements in order to maintain the coherency between the multiple copies of the same message stored on different storage units. Any alteration to one copy should be immediately reflected on the other copies of the messages. Synchronization creates additional complexity and workload to the system. Recovery methods have to be implemented to protect against transient synchronization failures, which could leave messages in a non-coherent state.

Moreover, with messaging system 10 of FIG. 1, re-allocation of resources, once a need for that raises, may be very hard and even impossible, due to the diversity of resources, and their diverse formats.

### SUMMARY OF THE INVENTION

A unified messaging system enables access to a variety of messaging devices and storage of messages in a single uniform e-mail attachment format. Furthermore, the system also provides e-mail messages to users without requiring said users to locally store said messages on a storage volume.

Furthermore, the system also enables all types and formats of received messages, to use message management options available for e-mail messages, such as “forward”, “reply”, “move to folder” etc.

### BRIEF DESCRIPTION OF THE DRAWINGS

The subject matter regarded as the invention is particularly pointed out and distinctly claimed in the concluding portion of the specification. The present invention will be better understood if read in conjunction with the following drawings, in which:

FIG. 1 is a schematic illustration of architecture of a unified messaging system according to the prior art;

FIG. 2 is a block diagram illustrating a message flow in a unified messaging system according to existing art;

FIG. 3 is a block diagram illustrating a messaging system operating according to the present invention;

FIG. 4 is a flow chart illustrating the conversion of message into e-mail with attachment according to the present invention;

FIG. 5 is a block diagram illustrating a message flow in a unified messaging system according to the present invention;

FIG. 6 is a schematic block diagram of system and method for converting stream-type media file retrieved Rough IMAP4 protocol into data construction compatible with a streaming protocol, constructed and working according to the present invention, and

FIGS. 7A, 7B and 7C are schematic illustrations of possible solutions for various network topologies constructed and operating according to the present invention.

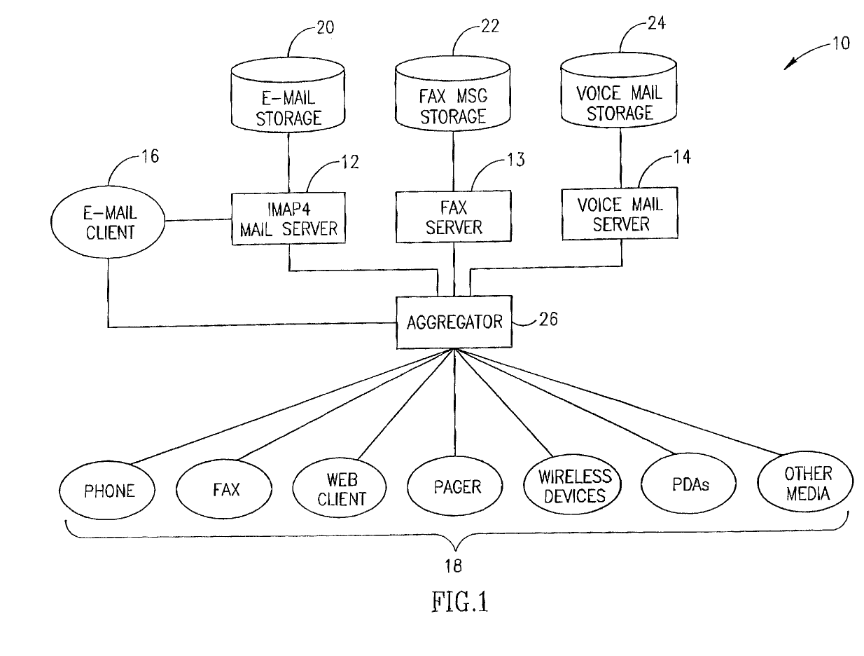

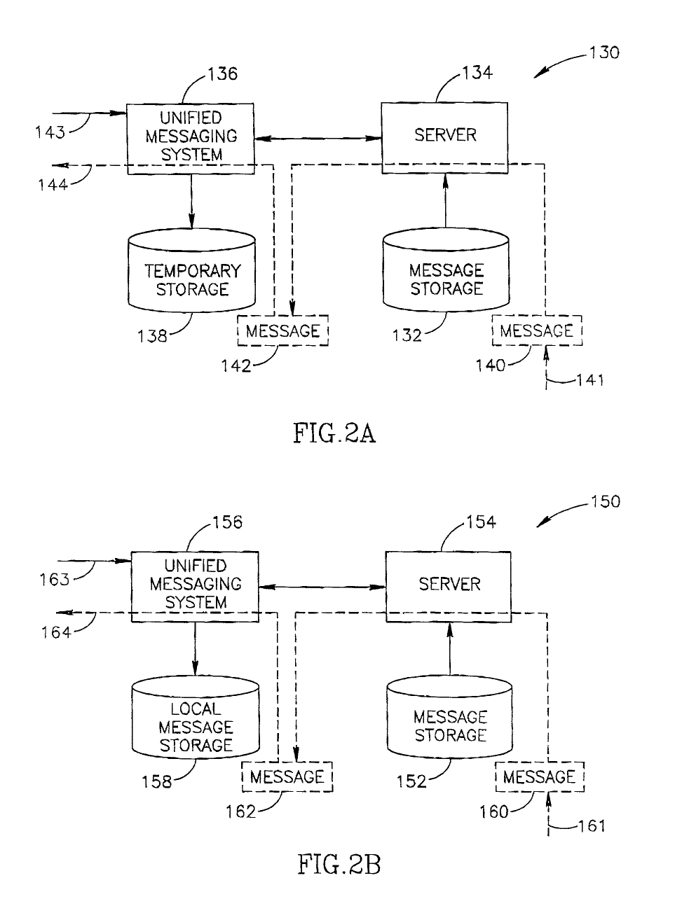

### DETAILED DESCRIPTION OF PREFERRED EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

There is thus provided, in accordance with one aspect of the present invention, a unified messaging system and method for receiving, storing, retrieving rerouting and the like, messages of any kind or format sent through a network, so that all the messages are stored and may be handled later on, in the same format.

There is also provided, in accordance with another aspect of the present invention, a unified messaging system and method that utilize only one storage means, in which only a single copy of a message is used, thus eliminating the need to create, maintain and handle multiple copies of a message and the overhead activity stemming from that.

Also provided, in accordance with another aspect of the invention, a unified messaging system that supports on-the-fly playback of stream-type messages retrieved from standard e-mail servers via IMAP4 protocol.

Also provided, in accordance with yet another aspect of the present invention, a unified messaging system and method with an open architecture that supports the incorporation of new messaging formats, subscribers or channels easily, without having to re-modify the system, and with minimum downtime.

There is also provided, in accordance with another aspect of the present invention, a unified messaging system and method that emulates a regular e-mail client thus allowing the system to access any standard e-mail server via any e-mail-client software.

Also provided, in accordance with still another aspect of the present invention, a unified messaging system and method that support virtual multi-domain unified messaging solutions on a single physical platform. Each of such virtual domains may operate independently from the other domains, with the capability to have its own branding, look, feel and enabled features.

Also provided, in accordance with yet another aspect of the present invention, a unified messaging system and method that can support virtually any number of users per each domain.

Also provided, in accordance with another aspect of the present invention a unified messaging system and method that support multiple languages in the system and in messages at the same time, through use of tools such as text-to-speech (TTS) engine. This system makes also use of language auto-detect tools, even when multiple languages are employed in a single message.

Also provided, in accordance with another aspect of the present invention, a unified messaging system and method that can automatically detect the format and protocol of the incoming message and automatically convert it into a corresponding native format, for storing and further handling of the message.

Also provided, in accordance with yet another aspect of the present invention, a unified messaging system and method supporting, upon retrieval of a stored message, various media conversions, according to the user's choice and to the nature of the device he uses, such as from mail to fax, from text to speech, etc.

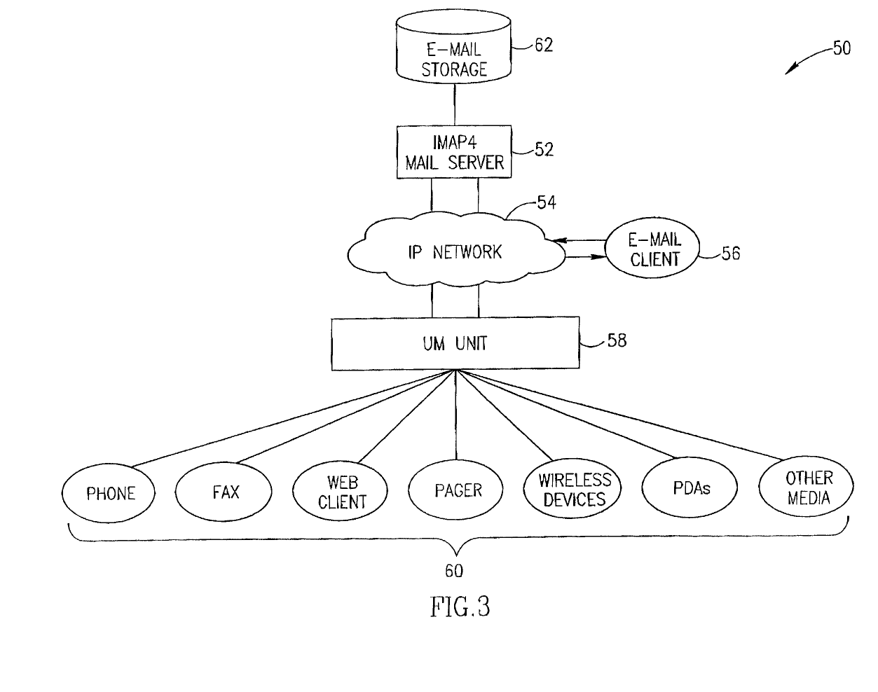

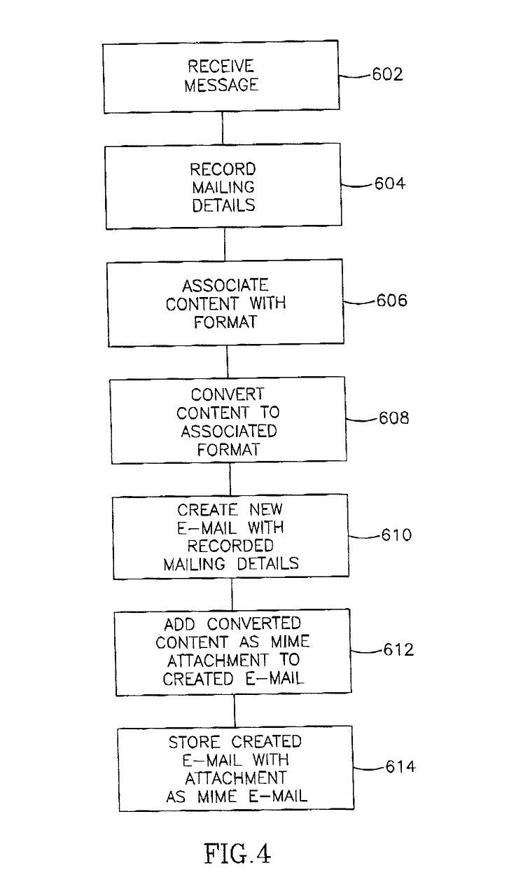

The present invention will be better understood if read in conjunction with FIGS. 3 and 4.

FIG. 3 illustrates a block diagram of a unified messaging (UM) system 50, in which an e-mail storage volume 62 is allocated in the storage facilities of a client's e-mail account to be used as storage means for all types of messages and mail sent to the client. Message sources 60 of various types are in operable connection with UM unit 58. UM unit 58, e-mail client 56 and IMAP4 mail server 52 are in operable connection with Internet Provider (IP) network 54. E-mail storage 62 is in operable connection with IMAP4 mail server 52. Storage volume 62 works in compliance with Multipurpose Internet Mail Extension (MIME) protocol. Messages received in UM unit 58 from any of message sources 60 supported by UM system 50 are identified, associated with one of the formats used for internal handling of the messages. Association of types of incoming messages with formats used for storing and retrieving of messages may be performed according to the following table of association:

TABLE 1

| Type of incoming | Stored as RFC 822 e-mail with MIME |
|---|---|
| message | attachment of type (association): |
| Voice | WAV/GSM |
| Fax | TIFF/F |
| Video | MPG4 |
| Text | TEXT/Plain |

It is understandable that the formats in Table 1, and their association with specific formats of messages are not limited to those in Table 1, and may vary as the case may be. Also new types of messages and new formats may be added.

FIG. 4 is a flow diagram illustrating the conversion of an incoming message into an e-mail type message according to the present invention. In step 602 an incoming message is received. Mailing details of the received message (i.e. identity and address of sender, identity and address of recipient, etc.) are then recorded (step 604), and the content of the incoming message is associated (step 606) with a specific attachment type, and then converted (step 608) to this attachment type. A new e-mail is then created (step 610), having the mailing details recorded in step 604 set as its mailing details. The converted media content is added (step 612) as an attachment to the newly created e-mail message. An incoming message whose content is of plain text type shall not undergo any conversion. Once a message is in an e-mail format, it is stored in the e-mail message storage 62 (FIG. 3) (step 614) as a standard e-mail message, (i.e. using an e-mail compliant format such as RFC822 format and including, if applicable, MIME attachments). Accordingly, the e-mail account of the user, as established in IMAP4 mail server 52, and its respective storage volume in message store 62, are used now for managing and storing of messages from message sources 60, regardless of their original format, needing no modifications (i.e. of the characteristics such as mailbox definitions, of e-mail address, of username and password, etc.). According to a preferred embodiment of the present invention, UM system 50 (FIG. 3), deploys standard client e-mail interface technology to communicate with the mail server. Therefore, regardless of the format of their media content, all converted messages are stored as standard e-mail in the e-mail server mailboxes.

A prompt to the user is invoked according to the regular policy of the e-mail service provider, to notify the user of a newly received message. When the message is retrieved, its content is brought to the user whether by way of displaying the text of the message (in case of a plain text messages), or by way of playing/displaying the content of the e-mail's attachment (e.g. video stream, voice message, TIFF image etc.). Retrieval of the stored message by the user using existing methods, especially when the message includes a stream-type media content attached to it, may be involved with an unacceptable latency, as discussed above.

According to another aspect of the present invention, innovative system and method (discussed in detail hereinbelow) are used to convert messages sent through IMAP4 protocol into data construction compatible with streaming protocol, thus enabling stored messages with stream-type media attachment to be retrieved through IMAP4 compliant protocol and be played on the fly in compliance with a streaming protocol.

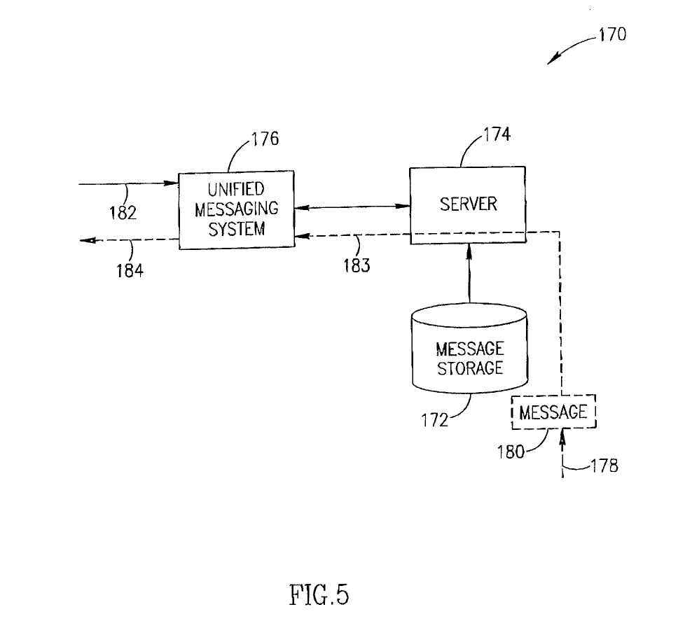

FIG. 5 exemplifies the typical flow of a message in a messaging system 170 built and operating according to the present invention. In this drawing the components of the system are drawn with solid lines and the flow of messages is drawn with dashed lines.

System 170 employs message storage 172 in operative connection with server 174. Server 174 is in operative connection with unified messaging system 176. In response to retrieval request (labeled 182) invoked by tie user (not shown), a message 180, stored earlier as an e-mail with attachment, is retrieved (labeled 178) from server 174 by unified messaging system 176 via IMAP4 protocol (labeled 183). Unified messaging system 176 performs on the fly conversion of the data construction of the message from MIME attachment received via IMAP4 into data construction or media compatible with the device retrieving the message. The converted data (labeled 184) is sent to the user device.

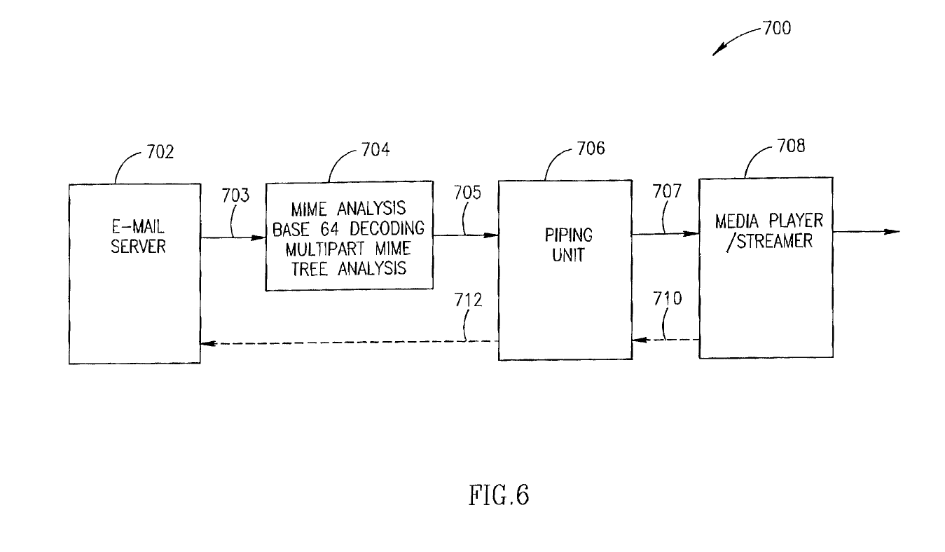

FIG. 6 is a schematic block diagram illustrating system 700 constructed and working according to another aspect of the present invention, capable of converting a message with stream-type attachment, retrieved through the IMAP4 protocol into a data construction compatible with a steaming protocol, thus making the message ready for on-the-fly retrieval.

E-mail server 702 is in operable connection with analyzer and decoder unit 704. Analyzer and decoder unit 704 is in operable connection with piping unit 706. Piping unit 706 is in operable connection with media player unit 708. A stream-type media file is retrieved (labeled 703) from e-mail server 702 through IMAP4 protocol. Analyzer and decoder unit 704 analyzes and decodes on the fly the MIME tree construction of the file. The analyzed and decoded blocks of data of the stream-type media file are then organized in a train-like order (labeled 705) and piped through piping unit 706, to create a standard stream construction, playable on-the-fly by a stream-type media player 708. Dashed lines labeled 710 and 712 illustrate the flow control invoked by media player 708 and by piping unit 706 respectively. It shall be understood that the units of the IMAP4-to-stream converter described hereinabove may be implemented either in hardware, or software or any appropriate combination of the two.

It shall be clear that the use of a IMAP4 to stream converter, built and operate according to the present invention, enables the retrieval of e-mail messages with stream-type media attachment without the need to create and store duplicate copies of the retrieved message, and without experiencing latency problems typical to messaging systems of existing art Thus, the extra workload of having to manage multiple copies of a message in a messaging system, as well as the deficiencies stemming from having to spare additional storage volume for these copies, are avoided.

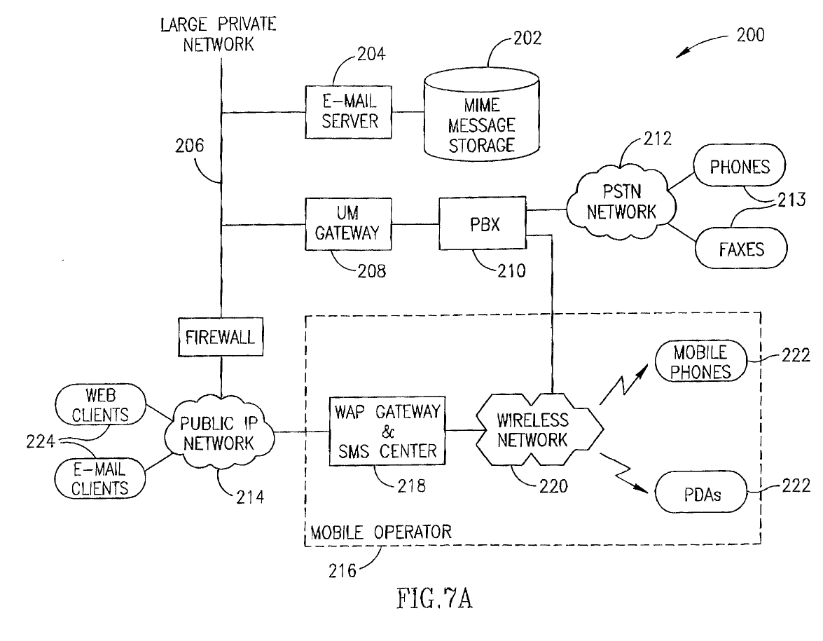

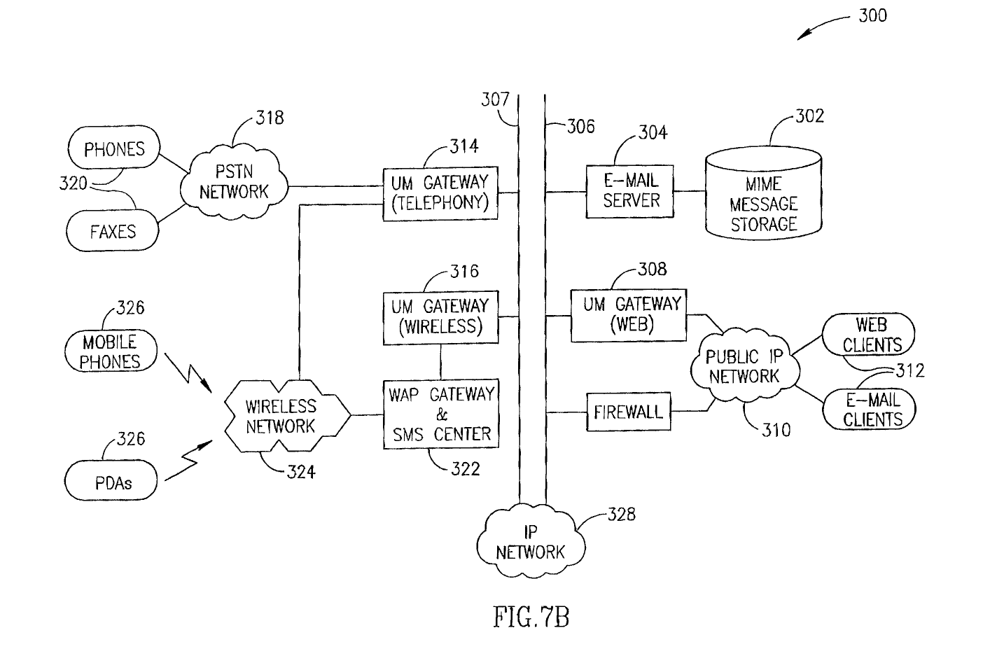

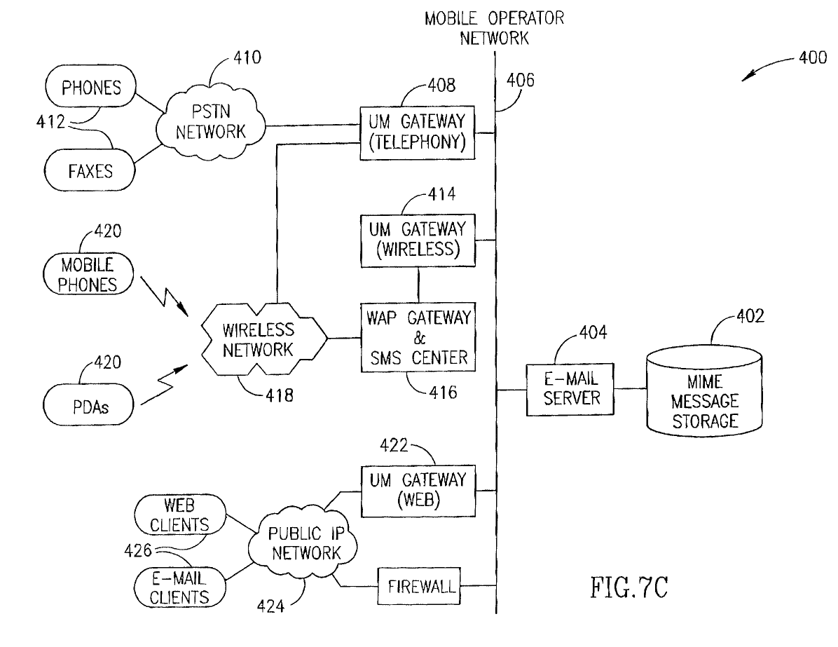

FIGS. 7A, 7B and 7C are schematic illustrations of various network topologies constructed and operating according to the present invention FIG. 7A illustrates a messaging system 200 implemented in a large private network. Messaging system 200 is serving various types of users such as phones, fax machines, mobile phones, Personal Digital Assistant (PDA) devices, e-mail clients and WEB clients.

In messaging system 200 MIME message storage unit 202 is accessible to network 206 via a standard e-mail server 204 (such as MS exchange of Microsoft Inc. or iPlanet from Sun Corp. both of USA). Phone or Fax messaging devices 213 have access to network 206 via Public Switched Telephone Network (PSTN) network 212, PBX 210 and UM gateway 208. Mobile phones and PDA devices 222 have access to network 206 via wireless network 220, via Wireless Application Protocol (WAP) gateway 218 and public IP network 214 for data delivery, and via Private Branch Exchange (PBX) 210 and UM gateway 208 for stream type media content (such as voice and video). WEB and e-mail clients have access to network 206 via public IP network 214.

All received messages in the system are stored in MIME message storage 202 as a MIME e-mail message with attachment, as described above in conjunction with FIGS. 3 and 4. MIME message storage 202 is exclusively accessed through e-mail server 204. Messaging devices which do not support an IMAP4 interface will access e-mail server 202 through UM gateway 208. In order to allow retrieval of stream type messages by stream type messaging devices, such as phones and faxes 213 and mobile phones 222 according to the present invention, an IMAP4 to stream converter, operating as described above in conjunction with FIG. 6, is incorporated into UM gateway 208. Hence, system 200 operates as a unified messaging system according to the description made in conjunction with FIG. 3, in which messaging devices have access to messages via UM gateway 208, and e-mail and WEB clients have access to messages via IP network. All managing tools and services such as forward, copy to folder, delete etc. are available to messaging devices and to e-mail and WEB clients, as applicable. If additional messaging device that supports retrieval of stream type media is to be added to system 200, an IMAP4 to stream converter shall be incorporated in a server or gateway providing this messaging device access to network 206. Employment of an IMAP4 to stream converter obviates the need to store duplicates of a stream type message retrieved by streaming messaging devices, hence making unified messaging system 200 a storageless messaging system.

FIG. 7B illustrates a messaging system 300 implemented in a communication environment constructed of two networks having an operable connection with each other via IP network 328. Network 306 on the right side of the drawing and network 307 on the left side of the drawing. Network 306 is a private network and network 307 is a mobile service provider network, in the example of FIG. 713. Messaging system 300 provides access to WEB and e-mail clients 312, to phone and fax devices 320 and to mobile phones and PDA devices 326.

MIME message storage 302 is accessible to network 306 via a standard e-mail server 304. WEB and e-mail clients are accessible to network 306 via public IP network 310 and UM gateway (WEB) 308 or via a firewall interface unit. Phone and fax devices are accessible to network 307 via PSTN network 318 and UM gateway 314. Mobile phones and PDA devices are accessible to network 307 via wireless network 324 and UM gateway 314 for stream type media content, or WAP gateway & Short Message Service (SMS) 322 and UM gateway 316 for data delivery.

Similar to system 200 described above, here also all messages are stored in MIME message storage 302 as a MIME e-mail message with attachment. Similarly, for messaging devices with streaming capability, such as phones 320 and mobile phones 326, an IMAP4 to stream converter is incorporated into UM gateway 314, thus making messaging system 300 a storageless unified messaging system.

FIG. 7C illustrates a messaging system 400 implemented based on a mobile network operator network 406. MIME message storage 402 is accessible to network 406 via a standard e-mail server 404. Phone and fax devices 412 are accessible to network 406 via PSTN network 410 and UM gateway 408. Mobile phones and PDA devices are accessible to network 406 via wireless network 418, and via UM gateway 408 for stream type media or via WAP gateway and SMS center 416 and UM gateway 414 for data delivery. WEB and e-mail clients 426 are accessible to network 406 via public IP network 424 and via UM gateway 422 or a firewall interface unit.

Similar to systems 200 and 300 described above, messaging system 400 stores all messages as a MIME e-mail messages with attachments, and supports retrieval and management of the messages using all managing tools available for e-mail messages to be used by each of the messaging devices, if applicable.

As can be noted from the description of FIGS. 7A, 7B and 7C, messaging systems constructed and operating according to the present invention provide a unified messaging system not only in the logical level but also in the physical level. Such unified messaging system provide unified access for messaging devices connected to it, stores all messages in one format in a single mail box, and supports enhanced managing tools to the user, such as forward message, move message to folder, etc. Being also able to incorporate an IMP4 to stream converter in the messaging system for supporting retrieval of stream type messages, the system can use a MIME storage unit of the user's e-mail account as its only storage volume, thus making the messaging system a storageless system.

Making the unified messaging system storageless permits a significant cost reduction of the system, a better use of existing storage means, a reduction in maintenance cost and a more effective utilization of existing maintenance infrastructure (anti-virus, backup etc.).

Mail accounts are universally accessible through Internet mail protocols. By using a mail account as the message storage area, the system enables any e-mail user to select his existing account as his storage area without any geographical constrains.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for handling electronic messages in a network, the method comprising the steps of:
each said message having mailing details and content, said content being in first format;
converting said first format of each said messages into a second format storable as an attachment to an e-mail;
creating an e-mail message with said mailing details and said converted content, and having said converted content as an attachment.

2. A messaging system comprising:
a server, constructed to receive messages and to create e-mail messages; and
a storage device in operable connection with said server,
a streaming unit to stream e-mail messages to a user, in operable connection with said server.
means for providing e-mail messages to users without requiring said users to locally store said messages.

3. A messaging server comprising:
conversion unit, constructed to convert a first format of message received in said server into an e-mail with an attachment and mailing details.

4. A method for enabling stream retrieval of stream type content from a Multi Purpose Internet Mail Extension (MIME) format storage in an Internet Messaging Access Protocol 4 (IMAP4) compliant network, comprising the steps:
analyzing the MIME data construction of said incoming stream type content;
decoding base64 decoding of said analyzed MIME data construction;
performing a second, multi-part MIME tree analysis of said decoded data;
reconstructing said second analyzed data in a stream-compatible data construction to generate an outgoing stream data construction asynchronous with said incoming stream data,
wherein said incoming stream type content and said outgoing data stream are asynchronous with each other.
